(19) United States
(12) Patent Application Publication
(10) Pub. No.: US 2011/0100065 A1
(43) Pub. Date: May 5, 2011

(54) Terminal Clamp for Horizontal Ear Bushing

(75) Inventors: Byron L. Bemis, Newark, OH (US); David F. Purvis, Newark, OH (US); Anthony P. Oakleaf, New Albany, OH (US)

(73) Assignee: OCV INTELLECTUAL CAPITAL, LLC, Toledo, OH (US)

(21) Appl. No.: 12/879,606

(22) Filed: Sep. 10, 2010

Related U.S. Application Data
(60) Provisional application No. 61/241,656, filed on Sep. 11, 2009.

(51) Int. Cl. C03B 37/08; F16B 2/02; F16M 13/02; F16B 2/12

(52) U.S. Cl. 65/475; 248/316.1; 248/226.11; 248/201; 248/316.4; 65/498; 65/495

(57) ABSTRACT

A terminal clamp assembly for a fiberizing bushing includes a clamp body having a firsts end face and a lower jaw, an auxiliary heat sink body selectively displaceable with respect to the clamp body, a contact assembly carried on the auxiliary heat sink body and an actuator to displace the heat sink body toward or away from the face of the clamp body. The invention also includes a bushing assembly incorporating the terminal clamp assembly and an expansion compensating mounting bracket for the clamp assembly.

This application claims priority to provisional application 61/241,656, filed Sep. 11, 2009, incorporated herein by reference.

### TECHNICAL FIELD AND INDUSTRIAL APPLICABILITY

This invention relates generally to the production of continuous glass filaments and, more particularly, to an improved terminal clamp, bushing assembly incorporating such a terminal clamp and method that allows adjusting of the operating temperature of a fiberizing bushing while the bushing is being used in the fiberizing operation.

### BACKGROUND

An excellent overview of the process of making glass, forming glass filaments and uses of filaments in various reinforcements and other materials is found in Loewenstein, K. L., “The Manufacturing Technology of Continuous Glass Fibres” 2nd Edition, Elsevier Science Publishers, (1983, original 1973), the entire contents of which are incorporated herein by reference.

Glass filaments are typically formed by attenuating molten glass through a plurality of orifices in a bottom plate of a bushing, and these filaments are frequently gathered into a strand. Conventional bushings typically include side plates, end plates and a bottom plate defining a bushing body therebetween. The bottom plate includes orifices or nozzles—perhaps more than four thousand—preferably all at or close to a uniform temperature for attenuating the molten glass. The bottom plate may also be referred to as a nozzle plate or tip plate.

Bushings are heated to a temperature sufficient to maintain the glass in a liquid state at all times—typically 2000 to 3000 degrees Fahrenheit—which also serves to condition the molten glass to a uniform temperature and viscosity so that the filaments are attenuated with a uniform diameter. The bushing's resistance to electrical current flow, known as the “Joule” effect, is the method most often used for heating the bushings to this high temperature, so bushings also include terminal ears attached at each end plate for conveying the electrical current to the bushing. Both the bushing and the terminal ears are typically made of a precious metal, such as a platinum-containing material like platinum-rhodium or platinum-iridium alloys in order to withstand such high temperatures. Terminal clamps are connected to the terminal ears to deliver a heating electric current from a transformer or other current source to the bushing.

A typical prior art terminal clamp is made from 100 percent pure copper and is bolted or otherwise clamped to the ear. The terminal clamp is typically water cooled as shown by U.S. Pat. Nos. 3,235,646 to Sens, and 3,409,072 to Stalego. Because of the relatively low melting point of copper, the terminal ear has to be long enough to position the copper clamp away from the high temperature bushing to a tolerable operating temperature for copper, as is taught in U.S. Pat. No. 6,427,492 to Sullivan, et al. and U.S. Pat. No. 4,740,224 to Fowler. The need for longer terminal ears requires the use of more precious metal alloy and increases the cost of producing the bushing.

Additionally, the location of the terminal clamp along the terminal ear affects the operating temperature of the bushing, as taught by, e.g. U.S. Pat. No. 4,740,224 to Fowler. When the terminal clamps are water cooled, moving the terminal clamp to a position on the terminal ear closer to the end plate and bottom plate of the bushing will make the bushing end colder. Conversely, moving the terminal clamp away from the bottom plate makes the bushing hotter. While controlling the bushing temperature by moving a terminal clamp in this manner is known in the art, it has been necessary in the past to discontinue the fiberizing process, unfasten the terminal clamp and re-secure it in a new position to achieve a desired temperature adjustment, all of which contribute to inefficiencies and loss of production time.

Finally, the use of longer terminal ears has caused bending and stress of the terminal ears under high temperatures and the weight of terminal clamps, which has led to the use of various angled configurations and support structures for the terminal ears and/or terminal clamps. Some examples are disclosed in U.S. Pat. No. 6,427,492 to Sullivan, et al. and U.S. Pat. No. 4,003,730 to Brady, et al.

The present invention relates to a new and improved terminal clamp, bushing assembly and method that provides for a secondary heat sink for directing heat away from the terminal ear, the position of which is adjustable along the terminal ear while the fiberizing process in ongoing to control adjustment of the bushing temperature in a more efficient manner.

### SUMMARY

In accordance with the purposes of the present invention as described herein, a new and improved terminal clamp assembly, bushing assembly and method for adjusting an operating temperature of a fiberizing bushing are disclosed. Thus, in one aspect, the invention relates to a terminal clamp assembly for a fiberizing bushing including a terminal ear and a support frame, said terminal clamp assembly, comprising:

a clamp body including a lower jaw at a first end of the clamp body for retaining a bushing terminal ear, and a primary heat sink for transferring heat away from said clamp body; and

an auxiliary heat sink body attached to said clamp body and having a contact assembly for contacting said terminal ear at a locus of contact that is distinct from said lower jaw, said auxiliary heat sink body including a secondary heat sink for transferring additional heat away from said clamp body.

In certain embodiments, the contact assembly is moveably attached to the clamp body for displacement between at least a first position and a second position, wherein in said first position the locus of contact with the terminal ear is nearer to the first end of the clamp body than when in the second position. Ideally, it is selectively displaceable to any of a plurality of positions between a first position at one extreme end and a second position at the other extreme end of displacement travel. An actuator is provided for displacing said contact assembly between the first and second positions. The actuator may be any of several types, including lever, wedge or rotary to cause the displacement.

In certain embodiments, the contact assembly is carried on an auxiliary heat sink body, which itself is moveably mounted to the clamp body to allow translational movement with respect to said clamp body, generally in a plane parallel to a plane that contains said terminal ear. In such case, the auxiliary heat sink body is attached to the clamp body by fastener means—such as a screw or bolt through an elongated slot—that allows for a sliding motion. Either one or both of the primary and secondary heat sinks may optionally comprise a fluid passage through which a coolant fluid flows.

The contact assembly may comprise a plurality of contact blocks carried in slots formed in said auxiliary heat sink body and the locus of contact then comprises the collective area of contact of each of said contact blocks. In some embodiments, the contact blocks are able to slide vertically in the slots and a spring or spring plate biases said contact blocks into engagement with the terminal ear. They may contain shoulders or serifs that retain them captive within the slots.

In some embodiments, the clamp body is composed of an alloy consisting predominantly of copper and nickel, with other elements being present in a total amount not more than about 25%, or not more than 10% in some cases. For example, the clamp body may consist essentially of copper in an amount from about 20% to about 90% and nickel in an amount from about 15% to about 85% and other elements in a total amount not to exceed 25%, ideally 10%, by weight. Such alloys generally should exhibit an operating temperature range of up to 1300 degrees F. and electrical resistivity of no more than 80 micro-ohm-centimeter (μΩ-cm). Advantageously, this allows a bushing to be made with a shorter terminal ear and, since terminal ears are made from expensive platinum alloy, this allows substantial reduction in the overall cost of manufacturing a bushing assembly.

In some embodiments, the contact assembly and/or the auxiliary heat sink body are composed of alloys consisting predominantly of iron, chromium and nickel with other elements being present in a total amount not more than about 25%, or not more than 10% in some cases. For example, either the contact assembly or the auxiliary heat sink body, or both, may comprise an alloy consisting essentially of chromium in an amount from about 10% to about 35%, iron in an amount from about 5% to about 60%, and nickel in an amount from about 25% to about 95% and other elements in a total amount not to exceed about 25%, ideally about 10% by weight. Such alloys generally should exhibit an operating temperature range of up to 2200 degrees F., thermal conductivity of up to 400 watt per meter-degree K (W/m-K), and electrical resistivity ranging between 80 and 140 micro-ohm-centimeter. (μΩ-cm).

In another aspect of the invention, a bushing assembly is provided that comprises: a bushing including a support frame, a bottom plate, side plates, end plates and at least two terminal ears; and at least one terminal clamp assembly as described in any of the embodiments above, wherein the lower jaw of the terminal clamp assembly is secured to said terminal ear, and the second locus of contact helps control the temperature by providing an alternate route for heat transfer. Generally, the terminal clamp will be one that has a contact assembly that is displaceable—as described above—along a terminal ear between a first position at one extreme end and a second position at the other extreme end of displacement travel. In some embodiments, the terminal clamp may be supported from a frame of the bushing my means of a compensating bracket system that supports the weight of the terminal clamp while at the same time, allowing for differential thermal expansion of the frame and the terminal clamp-terminal ear assembly. Such a compensating bracket may comprise a first bracket secured to said support frame, a second bracket secured to said clamp body, and a clamp support secured to said first bracket by a first pivot pin and to said second bracket by a second pivot pin. In variations, more than one terminal clamp may be secured to a single terminal ear. For example, a single terminal ear may have secured thereto at least two or three terminal clamp assemblies, each of which carries a contact assembly that may be adjusted to a different position for precise temperature control without ceasing the fiberizing process.

In yet another aspect, the invention includes a method for adjusting the operating temperature of a fiberizing bushing having a support frame, a terminal ear and, engaged with said terminal ear, any of the terminal clamps described above, said bushing having been heated and a fiberizing process initiated, said method comprising:

without interrupting said fiberizing operation, adjusting said locus of contact of said contact assembly along said terminal ear by displacing said contact assembly relative to said clamp body between at least a first position and a second position, wherein in said first position the locus of contact with the terminal ear is nearer to the first end of the clamp body than when in the second position.

In accordance with the method, in order to raise the temperature of a bushing end plate region, the contact assembly is displaced toward said first position; and to lower the temperature of a bushing end plate region, the contact assembly is displaced away from said first position. Preferably an actuator, such as a rotary actuator, is used to adjust the locus of contact, and the method comprises rotating said actuator. The method may further comprise the steps of engaging the terminal ear with a terminal clamp assembly as described above, and adjusting the initial second locus of engagement along the terminal ear by moving the contact assembly relative to the terminal ear. Further, the method may include the step of supporting the terminal clamp on the support frame while allowing for bushing expansion and contraction due to heating and cooling.

In another aspect of the invention, a terminal clamp assembly comprises:

a clamp body including a jaw slot at a first end of the clamp body for retaining a bushing terminal ear, wherein said clamp body is composed of an alloy consisting predominantly of copper and nickel with other elements being present in a total amount less than about 25%, and wherein said alloy exhibits an operating temperature range of up to 1300 degrees F. and electrical resistivity of no more than 80 micro-ohm-centimeter (μΩ-cm). For example, the clamp body may consist essentially of copper in an amount from about 20% to about 90% and nickel in an amount from about 15% to about 85% and other elements in a total amount not to exceed 25%, ideally 10%, by weight.

The terminal clamp assembly described immediately above may further comprise a contact assembly, wherein said contact assembly is composed of an alloy consisting predominantly of iron, chromium and nickel with other elements being present in a total amount up to about 25%, and wherein said alloy exhibits an operating temperature range of up to 2200 degrees F. and thermal conductivity of up to 400 watt per meter-degree K (W/m-K). For example, the contact assembly may comprise an alloy consisting essentially of chromium in an amount from about 10% to about 35%, iron in an amount from about 5% to about 60%, and nickel in an amount from about 25% to about 95% and other elements in a total amount not to exceed about 25%, ideally about 10% by weight.

In yet another aspect of the invention, a terminal clamp assembly is provided for a fiberizing bushing including a terminal ear and a support frame, and said terminal clamp assembly, comprises:

a clamp body including jaw portions defining a jaw slot at a first end of the clamp body for retaining a bushing terminal ear, and

an expansion compensating support system including a first bracket secured to said support frame, a second bracket secured to said clamp body, and a clamp support secured to said first bracket by a first pivot pin and to said second bracket by a second pivot pin, whereby the weight of said clamp body is supported on said frame by the expansion compensating support system while pivoting to allow for differential expansion of said frame and said clamp body.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is an exploded perspective view of the terminal clamp assembly of the present invention;

FIG. 2 is a side elevational view of the terminal clamp assembly of FIG. 1;

FIG. 3 is a front elevational view of the terminal clamp assembly of FIG. 1;

FIG. 4 is a top plan view of the terminal clamp assembly of FIG. 1;

FIG. 5 is a side elevational view of the bushing assembly (in partial cross section) including the terminal clamp assembly of the present invention; and

FIG. 6 is a perspective view, partially expanded, illustrating the compensating bracket system for mounting the terminal clamp assembly to the support frame of the bushing.

Reference will now be made in detail to certain embodiments of the invention, some examples of which are illustrated in the accompanying drawings.

### DETAILED DESCRIPTION OF THE INVENTION

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity.

Unless otherwise indicated, all numbers expressing ranges of magnitudes, such as angular degrees or sheet speeds, quantity or percent of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

As used herein, “heat sink” refers to any mechanism for enhancing the transfer of heat away from one location and dissipating it to another location(s). A heat sink may operate by conductive, radiative or convective processes, or a combination of any of these. Typical heat sinks include blades or fins that transfer heat to air flowing past, and fluid passages carrying coolant to which heat is transferred and removed.

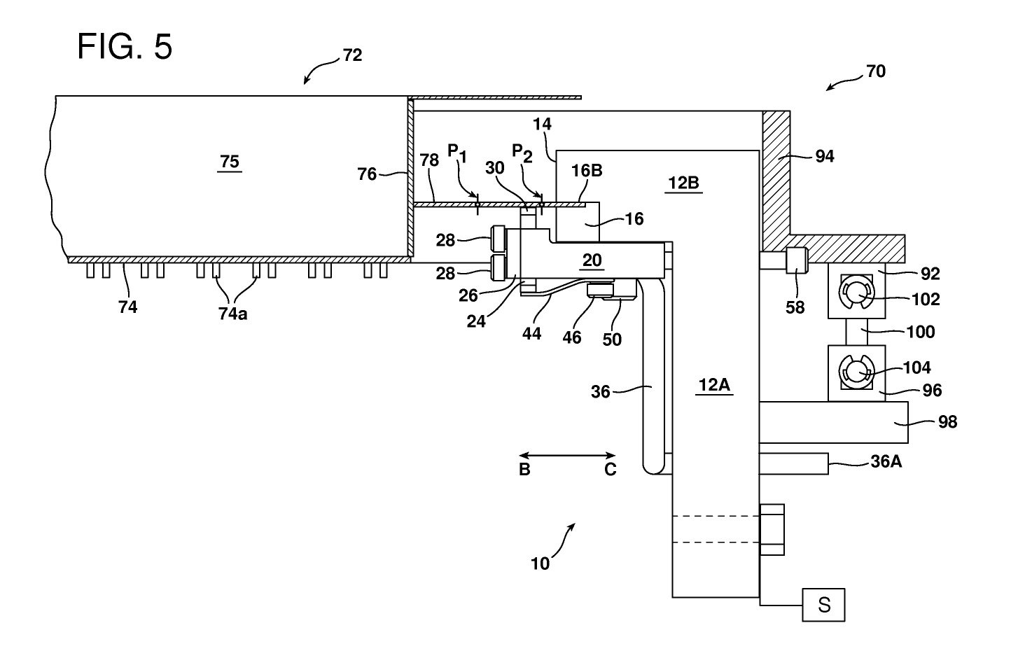

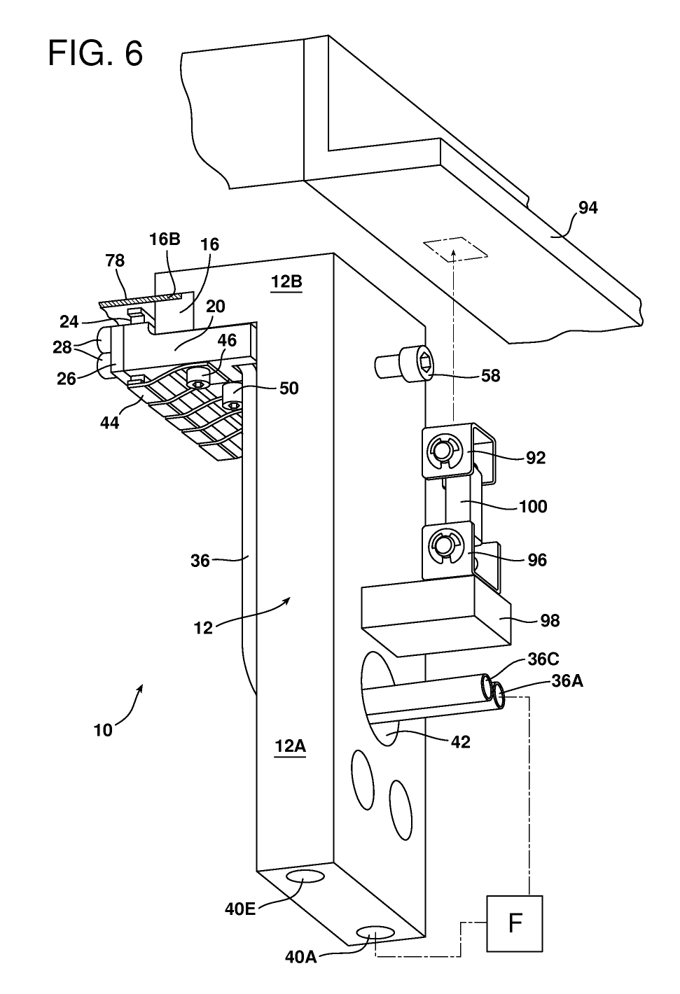

As used herein, “translational movement” means a back and forth reciprocating motion between two extreme end positions. As used in connection with the auxiliary heat sink body 20, translational movement implies movement in one direction that is away from the clamp body 12 and towards the bushing end wall 76, and in a reverse direction that is away from the bushing end wall 76 and towards the clamp body 12. The range of this translational movement is depicted in FIG. 4, wherein the auxiliary heat sink body 20 is shown in solid line in its first extreme end position closest to the end face 14 of the clamp head 12B, and in phantom line in its opposite extreme position furthest from the end face 14 of the clamp head 12B (and closest to a bushing). These extremes are also depicted in FIG. 5 as points P₂ and P₁, respectively.

As used herein, a “locus (loci) of engagement” and “locus (loci) of contact” are used interchangeably and refer to any of the various positions, intermediate or extreme, at which the contact assembly 22 engages or contacts the terminal ear 78 as the auxiliary heat sink body 20 moves through its range of translational movement.

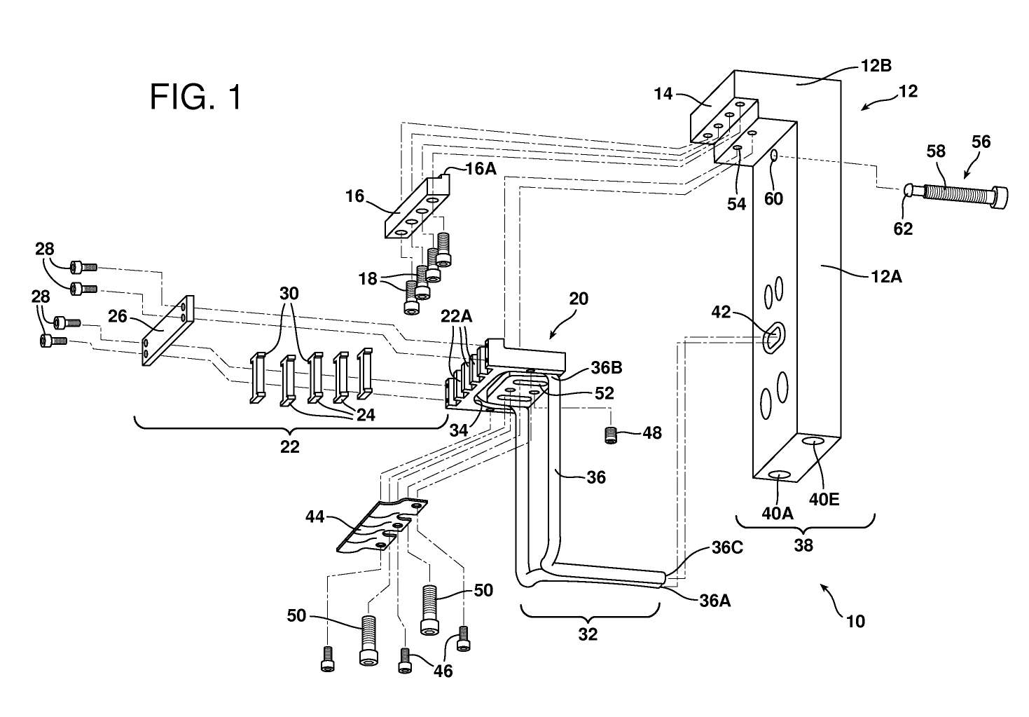

FIGS. 1-6 illustrate the terminal clamp assembly 10 of the present invention. The terminal clamp assembly 10 includes a clamp body 12 that is generally L-shaped (shown as an upside-down “L” in the Figures). The clamp body 12 includes a stem portion 12A and a head portion 12B arranged in generally orthogonal relationship. While other configurations are possible, this L-shape is convenient due to space considerations around a bushing assembly, and to provide a support for an actuator 56 to be described below. The head 12B includes at a first end face 14 having a recess designed to accommodate an accompanying lower jaw 16.

The lower jaw 16 is fastened to the head 12B of the clamp body 12 by means of a series of fastening screws 18. The lower jaw 16 cooperates with the recess of the head 12B to define a jaw slot 16B to receive and grasp a terminal ear 78 as is illustrated in FIGS. 5 and 6 to form a first and fixed point of engagement between the terminal ear 78 and the clamp assembly 10. The lower jaw 16 may optionally also include a recess 16A dimensioned to receive the terminal ear 78. The fastening screws 18 pass through cooperating, aligned holes (not shown) in the terminal ear 78 to which the clamp assembly 10 is connected. While the recesses of the head 12B and the lower jaw 16 are shown in the illustrated embodiments, they are not essential to the invention. Clamp assemblies 10 without such recesses or jaws may also be employed, and the term “jaw slot” as used herein means any clamping or securing means by which the clamp body is securely engaged with the terminal ear 78, without regard to whether or not definable “jaws” or hinge portions are present. At another end of the clamp stem 12A, a source of electrical current S (shown schematically in FIG. 5) is applied to the clamp body 12 via a terminal bolt or in another conventional manner known to those skilled in the art.

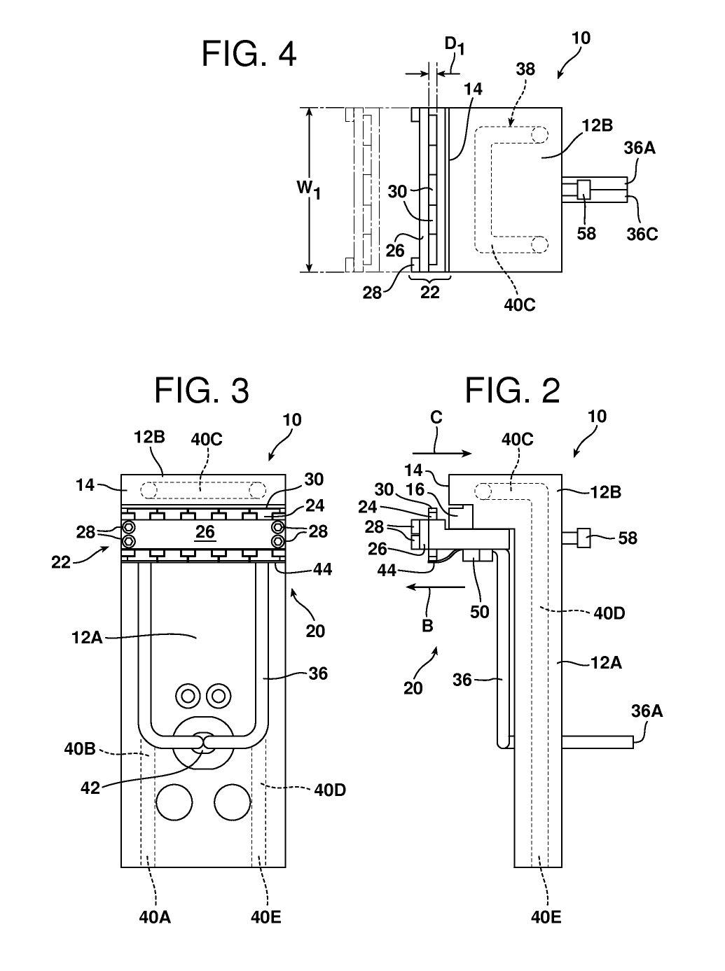

As illustrated best in FIGS. 2-4, the clamp body 12 includes a primary heat sink 38 for conducting heat away from the clamp body 12. Although other heat sink configurations are possible, in the illustrated embodiment the primary heat sink 38 comprises an internal coolant passageway 40 having an inlet 40A connected to a source of coolant fluid F (shown in FIG. 6). The inlet 40A continues to a riser 40B within the stem 12B, to a loop 40C within the head 12A, to a descender 40D also within the stem 12A, and finally to outlet 40E. Heat from the terminal ear 78 flows to the terminal clamp body 12 by means of fixed contact with the head 12B in the slot 16B and is conducted through the clamp body 12 to the primary heat sink 38. There, in a manner well known in the art, heat is transferred from the clamp body 12 to the coolant fluid and carried away from the clamp body, in order to maintain its temperature in a suitable operating range, which may be as high as 1500 F.

It should be appreciated then, that the first, fixed point of engagement between the clamp body 12 and the terminal ear 78 provides two functions: (1) to apply electrical current to heat the bushing, and (2) to remove heat from the terminal ear 78 via the primary heat sink 38. Consequently, the choice of materials for the clamp body 12 involves tradeoffs among the principal functional considerations. Paramount, it must have a sufficiently high operating temperature range to withstand the heat. The maximum operating temperature is always less than the melting temperature, and is usually limited by the tendency for oxidation, which negatively impacts both electrical conductivity and thermal conductivity at the interface of the clamp body 12 and the terminal ear 78. Thus, if a metal is used in an environment that exceeds its operating temperature, it usually will manifest in (1) an increase in the magnitude of the voltage drop at the terminal ear-clamp interface, and (2) a temperature increase in the terminal ear 78. Accordingly, an operating temperature range is bounded at the upper end by that temperature at which a metal oxidizes sufficiently to cause one or both of: (1) an increase of 0.2 volt or more in the magnitude of the ear-clamp interfacial voltage drop; and (2) a 50 degree F. or more increase in the temperature of the terminal ear; all other factors remaining constant (i.e. absent compensating measures).

A second principal factor is the electrical resistivity of the material, which must be low so that current is conducted effectively. Finally, a third principal factor is the thermal conductivity. It is desirable that the material have a high thermal conductivity to conduct heat effectively from the terminal ear 78 to the primary heat sink 38. Table 1 below sets forth possible ranges and more desirable ranges for each of these factors. Table 2 below sets forth representative alloy compositions and some commercially available alloys useful in connection with the invention. Other factors affecting a choice of materials in practice may include cost, weight, brittleness, strength, durability and other factors that will be readily apparent to those skilled in the art.

The terminal clamp assembly 10 also includes an auxiliary heat sink body 20 that is generally box-like and may be dimensioned to fit under the head 12B of the clamp body12, and adjacent the stem portion 12A—in other words, within the bend of the “L”. The auxiliary heat sink body 20 has four sides, a top face that generally abuts the underside of the head 12B, and a bottom face. The auxiliary heat sink body 20 carries or embodies two subcomponents to perform its major function: a contact assembly 22 and a secondary heat sink 32. These cooperate together to contact the terminal ear at a second locus of contact distinct from the first locus, and conduct heat from there to the secondary heat sink and away from the terminal ear. For this reason, the choice of materials for the auxiliary heat sink body 20 and its subcomponents, the contact assembly 22 and the secondary heat sink 32, also involves tradeoffs among the principal functional considerations. Both the auxiliary heat sink body 20 and the contact assembly 22 must have a sufficiently high operating temperature range, and this is a more rigorous requirement even than for the clamp body 12. The required operating temperature range may be as high as 2200 to 2400 F for the contact assembly 22 and, as before, the limiting factor in operating temperature is generally the tendency for oxidation. A second principal factor is the thermal conductivity; high thermal conductivity is required of all parts from the contact assembly 22 to the secondary heat sink 38 (including the auxiliary heat sink body 20) to conduct heat away from this second locus. Electrical conductivity is a less important factor for these components, so electrical resistivity (the inverse of conductivity) may be higher than for the clamp body 12. Table 1 below sets forth possible ranges and more desirable ranges for each of these factors. Table 2 below sets forth representative alloy compositions and some commercially available alloys useful in connection with the invention. Other factors affecting a choice of materials in practice may include cost, weight, brittleness, strength, durability and other factors that will be readily apparent to those skilled in the art.

TABLE 1
Electrical and Physical Characteristics of Components

| | | | Contact |
|---|---|---|---|
| | | Auxiliary Heat | Assembly/ |
| | Clamp Body | Sink Body | Blocks |
| Electrical Resistivity | | | |
| Range (Desirable) | 1-130 | 1-250 | 1-250 |
| (μΩ-cm) | (1-80) | (80-140) | (80-140) |
| Thermal Conductivity | | | |
| Range (Desirable) | 10-450 | 5-450 | 5-450 |
| (W/m-K) | (10-80) | (10-400) | (10-300) |
| Thermal Operating | 100-1300 | 200-2400 | 600-2400 |
| Range (Desirable) (F.) | (600-1100) | (400-1500) | (1000-2200) |

TABLE 2
Typical Alloy Compositions and Representative Alloys

| | | | Contact |
|---|---|---|---|
| | | Auxiliary Heat | Assembly/ |
| | Clamp Body | Sink Body | Blocks |
| Copper | 20-90% | other | other |
| Nickel or | 15-85% | 5-30% | 25-95% |
| Nickel/Cobalt | | | |
| Iron | other | 30-90% | 5-60% |
| Chromium | other | 10-35% | 10-35% |
| Other | up to 25% | up to 25% | up to 25% |
| Representative | MONEL K500 | 304 stainless steel | RA 330 (5) |
| Commercial | (1) | (4) | |
| Alloys (and | MONEL 400 | 310 stainless steel | RA 333 (5) |
| Source) | (1) | (4) | |
| | MARINEL 220 | 321 stainless steel | RA 602 CA (5 ) |
| | (2) | (4) | |
| | C71500 (3) | 316L stainless steel | INCONEL(1) |
| | | (4) | |

Source Key:
(1) Special Metals Corporation, WV
(2) Langley Alloys, UK
(3) National Bronze & Metals, Inc, TX
(4) ATI-Allegheny Ludlum, PA
(5) Rolled Alloys, MI

Thus, the clamp body 12 is generally made from an alloy composed predominantly of copper and nickel although other elements may be present in a total amount up to about 25%, but generally less than 10%. The relative amount of copper to nickel may vary widely. For example, from about 20% to about 90% copper and from about 15% to about 85% nickel; or more specifically from about 25% to about 75% copper and from about 20% to about 70% nickel, with other elements being present in a total amount up to about 10%. This provides the desired operating temperature and electrical conductivity with acceptable thermal conductivity.

The auxiliary heat sink body 20 may also made from alloys, although of somewhat different composition. Compared to the clamp body 12, high operating temperature is more important, but electrical conductivity is not required so low temperature copper can be avoided. Alloys for the auxiliary heat sink body 20 may be composed predominantly of chromium, iron and nickel, although other elements may be present in a total amount up to about 25%, but generally less than 10%. The relative amount of chromium, iron and nickel may vary widely. For example, from about 10% to about 35% chromium, from about 30% to about 95% iron, and from about 5% to about 30% nickel; or more specifically from about 15% to about 30% chromium, from about 45% to about 75% iron, and from about 8% to about 25% nickel.

The contact assembly 22 may also made from alloys, although of somewhat different composition. High operating temperature and thermal conductivity are most important here, but electrical conductivity is not required so low temperature copper can be avoided. Alloys for the contact assembly 22 may be composed predominantly of chromium, iron and nickel, although other elements may be present in a total amount up to about 25%, but generally less than 10%. The relative amount of chromium, iron and nickel may vary widely. For example, from about 10% to about 35% chromium, from about 5% to about 60% iron, and from about 25% to about 95% nickel; or more specifically from about 15% to about 30% chromium, from about 7% to about 45% iron, and from about 35% to about 80% nickel.

For alloy compositions of each of the three parts discussed above, it is to be understood that nickel may include nickel-cobalt complexes; other minor elements potentially useful and/or tolerable may include, for example, aluminum, carbon, cobalt, chromium, lead, magnesium, manganese, molybdenum, phosphorus, silicon, sulfur, tin, titanium, tungsten, zinc, and niobium; and all percents are based on weight.

As noted above, the auxiliary heat sink body 20 includes a secondary heat sink 32. As illustrated by the embodiment shown in FIG. 1, the secondary heat sink 32 comprises a channel 34 that receives a cooling coil 36. The cooling coil 36 has an inlet 36A connected to a source of coolant fluid F (shown in FIG. 6), a loop section 36B received in the channel 34 and an outlet 36C. Loop section 36B is connected to the inlet 36A and outlet 36C by means of riser and transverse sections of passageway. As shown in FIGS. 2, 3 and 6, the inlet and outlet 36A, 36C of the cooling coil 36 extend through an aperture 42 in the clamp stem 12B for facilitating fluid connections.

Also as noted above, the auxiliary heat sink body 20 also includes at least one contact assembly 22 for engaging the terminal ear 78 at a second locus of contact that is distinct from the fixed engagement in slot 16B of the clamp head 12B. The contact assembly 22 should make consistent contact with the terminal ear 78 in order to maintain efficient thermal conductance of heat away from the terminal ear 78 to the auxiliary heat sink body 20; and from there to the secondary heat sink 32 and away from the terminal clamp assembly 10. As used herein, the term “consistent contact” means that the contact assembly 22 maintains its engagement with the terminal ear 78 over a collective area that is sufficient to transfer heat from the terminal ear 78 to the auxiliary heat sink body 20 over all positions or “loci of engagement” across the full range of translational movement of the auxiliary heat sink body 20. “Consistent contact” thus depends on both the thermal conductivity of the contact assembly 22, and the collective area over which the contact assembly 22 contacts the terminal ear 78 which, in turn, is the product of the combined width W1 and depth D1 of the contact assembly(ies) 22.

While many suitable contact assemblies 22 are possible, in the illustrated embodiment, the contact assembly 22 comprises a series of five receiver slots 22A for receiving and holding five contact blocks 24 in substantially linear alignment. Each receiver slot 22A comprises an elongated notch separated by a bar of body material, and each contact block 24 is I-shaped having “serifs” or enlarged shoulders 30 at each end. An end plate 26 is received on the auxiliary heat sink body 20 so as to close the open end of the receiver slots 22A and capture the contact blocks 24 in the contact assembly 22. Fasteners in the form of screws 28 hold the end plate 26 in position. As should be appreciated, the enlarged shoulders 30 of each contact block 24 serve to render the contact blocks 24 captive in the receiver slots 22A while allowing some movement in the longitudinal/vertical direction. The enlarged shoulder 30 of each contact block 24 has face parallel to the terminal ear that has a width and depth such that the collective width W1 times the collective depth D1 of all contact blocks 24 defines the area of contact with the terminal ear 78.

A spring plate 44 is secured to the bottom face of the auxiliary heat sink body 20 and biases the contact blocks 24 upward into consistent contact with the terminal ear 78. While five receiver slots 22A and five contact blocks 24 are shown in the illustrated embodiment, fewer or greater number of receiver slots and contact blocks 24 could be provided if desired. The contact blocks 24 and their receiver slots 22A are merely one convenient way to assure consistent contact and heat transfer. The spring plate 44 is secured to the auxiliary heat sink body 20 by means of fasteners such as the screws 46. A set screw 48 allows one to adjust the upward biasing force provided on the contact blocks 24 by the spring plate 44. Fasteners 50 extend through notches in the spring plate 44 and as well as through the elongated slots 52 in the auxiliary heat sink body 20 and threadedly engage the apertures 54 in the clamp body 12.

In a preferred embodiment, the fasteners 50 are not tightened sufficiently to bind the auxiliary heat sink body 20 in position against the clamp body 12. Rather, the fasteners 50 slideably hold the auxiliary heat sink body 20 to the clamp body 12 and allow for translational movement of the contact assembly 22 (as part of the auxiliary heat sink body 20) toward or away from the face end 14 of the clamp body 12. Furthermore, the top face of the auxiliary heat sink body 20 and the bottom face of the clamp head portion 12B may optionally contain grooves or guides for facilitating translational movement. The purpose of this translational movement is described momentarily. In this embodiment, because the auxiliary heat sink body 20 carries both the contact assembly 22 and the secondary heat sink 32 within its body, each of these engages in translational movement relative to the clamp body 12 and terminal ear 78. However, it should be understood that when translational movement is desired, only the contact assembly 22 need engage in translational movement. In an alternate arrangement, the auxiliary heat sink body 20 and/or the secondary heat sink 38 may be stationary relative to the clamp body 12, provided the contact assembly 22 is selectively displaceable and makes sufficient contact also with the secondary heat sink apparatus to effectively transfer heat.

Referring again to the embodiment illustrated in FIGS. 1-6, an actuator 56 achieves this translational movement of the auxiliary heat sink body 20 relative to the clamp body 12, and since the clamp body 12 is fixedly secured to the terminal ear 78, the auxiliary heat sink body 20 also moves relative to the terminal ear 78. Actuator 56 may be a lever type, wedge type or a rotary type as three convenient examples. A lever type employs a fulcrum and applies leverage to adjust the position of auxiliary heat sink body 20; a wedge type actuator achieves this translational movement by moving its inclined plane transversely in a cross direction between the two bodies 12, 20; and a rotary type actuator achieves translational movement by a screw or thread means, such as a worm gear or a draw bolt.

In the illustrated embodiment, the actuator 56 is a draw bolt 58 that threadedly engages in an aperture 60 in the clamp body 12. The nose 62 of the draw bolt 58 is received and held in a cavity or slot (not shown) in the rear wall of the auxiliary heat sink body 20. As the actuator 58 is rotated in a first direction, the actuator forces the auxiliary heat sink body 20 to move away from the face 14 of the clamp body 12 in the direction of action arrow B illustrated in FIG. 2. In contrast, as the actuator 58 is rotated in the opposite direction, the auxiliary heat sink body 20 is forced to move in the direction of action arrow C toward the face 14 of the clamp body 12.

Reference is now made to FIG. 5 illustrating the bushing assembly 70 including the terminal clamp assembly 10 of the present invention. For clarity, only one end of the bushing assembly 70 is illustrated in FIG. 5, but it should be appreciated that the opposite, un-shown end is a mirror image of the illustrated structure. As illustrated, the bushing assembly 70 includes a bushing 72 including a bottom plate 74, side plates or walls 75 (only the rear side plate is visible in the drawing figure) and an end plate or wall 76. For clarity, the typical refractory casting around the bushing 72 has not been shown. A series of orifices 74A are provided in the bottom plate 74. Molten glass in the bushing 72 passes through the orifices 74A during the fiberization process. As further illustrated in FIG. 5, the bushing 72 includes a terminal ear 78 extending from the end wall 76.

As illustrated, the terminal ear 78 is a flat horizontal plate. The end of the terminal ear 78 is received in the jaw slot 16B defined between the clamp head 12B and the lower jaw 16 as described above. The fastening screws 18 (shown in FIG. 1) are tightened down to secure the margin of the terminal ear 78 in the jaw slot 16B forming a first or primary point of engagement of the terminal clamp assembly 10 with the terminal ear. When the terminal clamp assembly 10 is properly positioned on the terminal ear 78 (as shown in FIG. 5), the spring plate 44 biases the contact blocks 24 upwardly so that the top shoulder 30 of each contact block 24 engages and makes consistent contact with the terminal ear 78 at a second locus of engagement. The second locus of engagement of the contact assembly 22 serves to provide a secondary or auxiliary route to transfer heat away from the terminal ear 78; a route which, in a preferred embodiment, is selectively alterable for reasons discussed below.

During the fiberizing process, molten glass in the bushing 72 passes through the orifices 74A to form a series of glass filaments. The molten glass in the bushing 72 is heated by an electric current delivered through the terminal clamp assembly 10 and the terminal ear 78. To achieve this end, the clamp body 12, auxiliary heat sink body 20 and contact block 24 of the terminal clamp assembly 10 should all be made of alloys having a high temperature operating range, as noted previously. Advantageously, these preferred alloys have a much higher operating temperature range than pure copper and, accordingly, the terminal clamp assembly 10 may be positioned much closer to the bushing 72 and the molten glass. Consequently, the terminal ear 78 may be made much shorter, from less material. Since the terminal ear is made from expensive platinum alloy, this substantially reduces the cost of producing the terminal ear 78 of the bushing 72.

During the fiberizing process, it is desirable to maintain a uniform temperature of the molten glass in the bushing 72. This is because the temperature of the molten glass in the bushing 72 has a direct effect on viscosity and on the operating efficiency and the ultimate diameter of the glass filaments produced through the orifices 74A. However, convection currents, electrical resistance variances and other factors tend to cause non-uniform temperatures in the bushing 72, so it is desirable to control the temperature of the bushing 72. Advantageously, the clamp assembly 10 of the present invention allows one to control more precisely the temperature of the bushing 72, particularly at its ends, without interrupting the fiberizing operation. More specifically, by selectively moving the contact assembly 22 toward or away from the face 14 of the clamp body 12 one moves the second locus of contact and can selectively lengthen or shorten, respectively, the alternate heat transfer route through the contact assembly 22 and the secondary heat sink 32 which, in turn, warms or cools (respectively) the terminal ear 78 and end region of bushing 72. Actuator 56 provides for this selective movement of the auxiliary heat sink body 20 and its contact assembly 22, as described above.

In the embodiment illustrated in FIG. 5, it should be appreciated that the jaw slot 16B extends in a first plane that includes the horizontally extending terminal ear 78. The auxiliary heat sink body 20 is mounted to the clamp body 12 by means of the fasteners 50 that extend through the elongated slots 52 in a manner that allows translational movement of the auxiliary heat sink body 20 with respect to the clamp body 12 in a second plane parallel to the first plane. As a consequence, a method is provided for adjusting the operating temperature of the fiberizing bushing 72 without having to interrupt the fiberizing process. As initial steps, it is presumed that one or more terminal clamp assemblies are attached to terminal ears of a bushing. It is further presumed, in the case of displaceable auxiliary heat sink bodies, that an initial point of engagement of contact block 24 with the terminal ear 78 is established somewhere between the two extreme end positions.

One proceeds to practice the method of the invention by rotating the draw bolt actuator 58 in either direction from a midpoint to adjust the point of engagement of the contact block 24 with the terminal ear 78. Thus, the second locus of contact may be moved anywhere between the points P₁ and P₂. As the second locus of engagement is moved away from the face 14 and toward the bushing 72, including the end plate 75 and bottom plate 74, the temperature of the bushing 72 and, therefore, the molten glass in the bushing is lowered by the cooling fluid circulating through the cooling coil 36 carried by the auxiliary heat sink body 20. The extreme innermost position P₁ provides the coolest operating temperature for the bushing 72. In contrast, as the locus of engagement is moved toward the face 14 and away from the end plate 75 and bottom plate 74 of the bushing 72, the temperature of the bushing and the molten glass contained therein is increased. The point P₂ represents the opposite, outermost extreme position of translational movement, and also the hottest operating temperature for the bushing 72.

Significantly, it should be appreciated that the position of the auxiliary heat sink body 20 and, therefore, the point of contact between the contact block 24 and the terminal ear 78 may be adjusted even during the fiberizing operation. Accordingly, no production time is lost during temperature adjustments using the terminal clamp assembly 10 of the present invention. Additionally, more precise temperature control may be achieved by using multiple terminal clamp assemblies 10 according to the invention, for example two or more, across each terminal ear 78. In this way, each contact assembly 22 may be adjusted separately to the same or different distance from the bushing 72.

As noted above, the design of the clamp assembly 10 allows the ear 78 to be made shorter and from less material. As such, the ear 78 is not as strong as it could be. Therefore, it may be desirable to support the weight of the clamp assembly 10 to keep it off the ear 78. It should also be appreciated that, due to the temperature extremes, substantial expansion and contraction of the components of the bushing assembly 70 takes place during the heating and cooling cycles. Advantageously, the terminal clamp assembly 10 incorporates a compensating bracket system, generally designated by reference numeral 90 that not only supports the clamp assembly but also fully accommodates any expansion and contraction. As illustrated in FIGS. 5 and 6, the compensating bracket system 90 includes a first bracket or trunion 92 mounted to the support frame 94 of the bushing. A second bracket or trunion 96 is mounted to a lug 98 carried on the clamp body 12. A clamp support 100 is secured at a first end to the first bracket 92 by means of a first pivot pin 102 and at a second end to the second bracket 96 by means of a second pivot pin 104. The terminal clamp assembly 10 may be electrically isolated from the support frame 94 by making either the lug 98 and/or the clamp support 100 from an electrically insulating material. In all embodiments, the clamp assembly should be electrically isolated from the frame.

The compensating bracket system 90 provides two cooperating pivot points at each of the pivot pins 102, 104. As the various components of the bushing assembly 70, including, for example, the bushing 72, terminal ear 78 and support frame 94, expand and contract during heating and cooling, the clamp assembly 10 is free to move to accommodate the bushing expansion and contraction. At all times, the dual pivot points of the compensating bracket system 90 maintain the terminal clamp assembly 10 with the proper geometry to fully receive and hold the end of the terminal ear 78 in the jaw slot 16B.

The foregoing description of the preferred embodiments of the present invention have been presented for purposes of illustration and description. It is not intended to be exhaustive or to limit the invention to the precise form disclosed. Obvious modifications or variations are possible in light of the above teachings. For example, the clamp body 12 may be made from pure copper while only the auxiliary heat sink body 20 and contact block 24 are made from the high temperature alloy. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way. In some embodiments of the invention, certain features of the invention may be used to advantage without a corresponding use of other features.

What is claimed:

1. A terminal clamp assembly for a fiberizing bushing including a terminal ear and a support frame, said terminal clamp assembly, comprising:
a clamp body including a lower jaw at a first end of the clamp body for retaining a bushing terminal ear, and a primary heat sink for transferring heat away from said clamp body; and
an auxiliary heat sink body attached to said clamp body and having a contact assembly for contacting said terminal ear at a locus of contact that is distinct from said lower jaw, said auxiliary heat sink body including a secondary heat sink for transferring additional heat away from said clamp body.

2. The terminal clamp assembly of claim 1, wherein said contact assembly is moveably attached to said clamp body for displacement between at least a first position and a second position, wherein in said first position the locus of contact with the terminal ear is nearer to the first end of the clamp body than when in the second position.

3. The terminal clamp assembly of claim 2, further comprising an actuator for displacing said contact assembly between at least the first and second positions.

4. The terminal clamp assembly of claim 3, wherein said contact assembly is selectively displaceable to any of a plurality of positions between a first position at one extreme end and a second position at the other extreme end of displacement travel.

5. The terminal clamp assembly of claim 4, wherein said actuator is a rotary-type actuator that causes said displacement upon rotation.

6. The terminal clamp assembly of claim 5, wherein said actuator is a draw bolt that threadedly engages in a hole in said body and includes a nose that is connected to said heat sink body.

7. The terminal clamp assembly of claim 1, wherein at least one of the primary and secondary heat sinks comprises a fluid passage through which a coolant fluid flows.

8. The terminal clamp assembly of claim 7, wherein both the primary and secondary heat sinks comprise a fluid passage through which a coolant fluid flows.

9. The terminal clamp assembly of claim 2, wherein said contact assembly is carried on an auxiliary heat sink body that is moveably mounted to the clamp body to allow translational movement with respect to said clamp body in a plane parallel to a plane that contains said terminal ear.

10. The terminal clamp assembly of claim 9, including at least one fastener securing said auxiliary heat sink body to said clamp body, and wherein said at least one fastener extends through an elongated aperture in said auxiliary heat sink body.

11. The terminal clamp assembly of claim 10, further including a spring plate carried on said auxiliary heat sink body, said spring plate biasing said contact block into engagement with the terminal ear.

12. The terminal clamp assembly of claim 1, wherein said contact assembly comprises plurality of contact blocks carried in slots formed in said auxiliary heat sink body, and the locus of contact comprises the collective area of contact of each of said contact blocks.

13. The terminal clamp assembly of claim 1, further including a compensating bracket system mounting said clamp body to a support frame of said bushing.

14. The terminal clamp assembly of claim 13, wherein said compensating bracket system includes a first bracket secured to said support frame, a second bracket secured to said clamp body, and a clamp support secured to said first bracket by a first pivot pin and to said second bracket by a second pivot pin.

15. The terminal clamp assembly of claim 1, wherein said terminal clamp is electrically isolated from said support frame of said bushing.

16. The terminal clamp assembly of claim 1, wherein said contact assembly and said auxiliary heat sink body are composed of alloys comprising iron, chromium and nickel with other elements being present in a total amount up to about 25%.

17. The terminal clamp assembly of claim 16, wherein said alloys exhibit an operating temperature range of up to 2200 degrees F., thermal conductivity of up to 400 watt per meter-degree K (W/m-K), and electrical resistivity ranging between 80 and 140 micro-ohm-centimeter. (μΩ-cm).

18. A bushing assembly, comprising:
a bushing including a support frame, a bottom plate, side plates, end plates and at least two terminal ears; and at least one terminal clamp assembly according to claim 2, wherein the lower jaw of the terminal clamp assembly is secured to said terminal ear.

19. The bushing assembly of claim 18, wherein said contact assembly is selectively displaceable to any of a plurality of positions between a first position at one extreme end and a second position at the other extreme end of displacement travel, and further comprising a rotary-type actuator that causes said displacement upon rotation.

20. The bushing assembly of claim 18, wherein both the primary and secondary heat sinks comprise a fluid passage through which a coolant fluid flows.

21. The bushing assembly of claim 18, further including a compensating bracket system securing said terminal clamp assembly to said support frame.

22. The bushing assembly of claim 18, further comprising at least three terminal clamp assemblies and wherein at least one terminal ear has secured thereto at least two terminal clamp assemblies.

23. A method for adjusting the operating temperature of a fiberizing bushing having a support frame, a terminal ear and a terminal clamp assembly according to claim 2 engaged with said terminal ear, said bushing having been heated and a fiberizing process initiated, said method comprising:
without interrupting said fiberizing operation, adjusting said locus of contact of said contact assembly along said terminal ear by displacing said contact assembly relative to said clamp body between at least a first position and a second position, wherein in said first position the locus of contact with the terminal ear is nearer to the first end of the clamp body than when in the second position.

24. A method for adjusting the operating temperature of a fiberizing bushing having a support frame, a terminal ear and a terminal clamp assembly according to claim 4 engaged with said terminal ear, said bushing having been heated and a fiberizing process initiated, said method comprising:
without interrupting said fiberizing operation, adjusting said locus of contact of said contact assembly along said terminal ear by displacing said contact assembly relative to said clamp body between any of a plurality of positions between a first position and a second position, wherein in said first position the locus of contact with the terminal ear is at one extreme end nearest to the first end of the clamp body and a second position at the other extreme end of displacement travel furthest from the first end of the clamp body.

25. The method of claim 24, wherein in order to raise the temperature of a bushing end plate region, the contact assembly is displaced toward said first position.

26. The method of claim 24, wherein in order to lower the temperature of a bushing end plate region, the contact assembly is displaced away from said first position.

27. The method of claim 24, wherein said actuator comprises a rotary-type actuator and said adjusting the locus of contact comprises rotating said actuator.

28. A terminal clamp assembly for a fiberizing bushing including a terminal ear, said terminal clamp assembly, comprising:
a clamp body including a jaw slot at a first end of the clamp body for retaining a bushing terminal ear, wherein said clamp body is composed of an alloy comprising copper and nickel with other elements being present in a total amount up to about 25%, and wherein said alloy exhibits an operating temperature range of up to 1300 degrees F. and electrical resistivity of no more than 80 micro-ohm-centimeter (μΩ-cm).

29. The terminal clamp assembly of claim 28, wherein said alloy comprises copper and nickel with other elements being present in a total amount up to about 10%.

30. The terminal clamp assembly of claim 28, wherein said alloy consists essentially of copper in an amount from about 20% to about 90% and nickel in an amount from about 15% to about 85% with other elements being present in a total amount up to about 10%.

31. The terminal clamp assembly of claim 31, wherein said alloy consists essentially of copper in an amount from about 25% to about 75% and nickel in an amount from about 20% to about 70%, with other elements being present in a total amount up to about 10%.

32. The terminal clamp assembly of claim 28, further comprising a contact assembly, wherein said contact assembly is composed of an alloy comprising iron, chromium and nickel with other elements being present in a total amount up to about 25%, and wherein said alloy exhibits an operating temperature range of up to 2200 degrees F. and thermal conductivity of up to 400 watt per meter-degree K (W/m-K).

33. The terminal clamp assembly of claim 32, wherein said contact assembly alloy comprises iron, chromium and nickel with other elements being present in a total amount up to about 10%.

34. The terminal clamp assembly of claim 32, wherein said contact assembly alloy consists essentially of chromium in an amount from about 10% to about 35%, iron in an amount from about 5% to about 60%, and nickel in an amount from about 25% to about 95% with other elements being present in a total amount up to about 10%.

35. The terminal clamp assembly of claim 34, wherein said contact assembly alloy consists essentially of chromium in an amount from about 15% to about 30%, iron in an amount from about 7% to about 45%, and nickel in an amount from about 35% to about 80% with other elements being present in a total amount up to about 10%.

36. A terminal clamp assembly for a fiberizing bushing including a terminal ear and a support frame, said terminal clamp assembly, comprising:
a clamp body including jaw portions defining a jaw slot at a first end of the clamp body for retaining a bushing terminal ear, and
an expansion compensating support system including a first bracket secured to said support frame, a second bracket secured to said clamp body, and a clamp support secured to said first bracket by a first pivot pin and to said second bracket by a second pivot pin, whereby the weight of said clamp body is supported on said frame by the expansion compensating support system while pivoting to allow for differential expansion of said frame and said clamp body.
